(19) United States
(12) Patent Application Publication
(10) Pub. No.: US 2024/0072363 A1
(43) Pub. Date: Feb. 29, 2024

(54) MULTI-LAYERED ENCLOSURE COVERS FOR TRACTION BATTERY PACKS

(71) Applicant: FORD GLOBAL TECHNOLOGIES, LLC, Dearborn, MI (US)

(72) Inventors: Ravi Saripella, Farmington Hills, MI (US); Melissa Kathryn Christensen, New Hudson, MI (US); Jason Luke Sielaff, Brighton, MI (US); Ryan Shanahan, Royal Oak, MI (US); Gautam Chatterji, Cambridgeshire (GB); Vasko Iliev, West Bloomfield, MI (US)

(21) Appl. No.: 17/893,453

(22) Filed: Aug. 23, 2022

(51) Int. Cl. H01M 50/282; B32B 3/04; B32B 5/18; B32B 15/01; B32B 15/04; B32B 15/18; B32B 15/20; H01M 10/0525; H01M 10/613; H01M 10/625; H01M 10/658; H01M 50/204; H01M 50/249; H01M 50/262; H01M 50/276; H01M 50/278

(52) U.S. Cl. CPC H01M 50/282; B32B 3/04; B32B 5/18; B32B 15/012; B32B 15/046; B32B 15/18; B32B 15/20; H01M 10/0525; H01M 10/613; H01M 10/625; H01M 10/658; H01M 50/204; H01M 50/249; H01M 50/262; H01M 50/276; H01M 50/278; B32B 2250/03; B32B 2250/40; B32B 2266/0278; B32B 2307/306; B32B 2457/10; H01M 2220/20

(57) ABSTRACT

Traction battery packs are disclosed for use in electrified vehicles. Exemplary traction battery packs may include an outer enclosure assembly establishing an interior, and a battery array housed within the interior. The outer enclosure assembly includes a multi-layered enclosure cover designed to withstand the high temperature environment of the traction battery pack while also providing weight savings. In some embodiments, the multi-layered enclosure cover is a roll-bonded structure that includes an inner layer, an outer layer, and a mid-layer. The various layers of the roll-bonded structure may be constructed out of various materials.

### TECHNICAL FIELD

This disclosure relates generally to electrified vehicle traction battery packs, and more particularly to multi-layered enclosure covers for traction battery packs.

### BACKGROUND

A high voltage traction battery pack typically powers an electric machine and other electrical loads of an electrified vehicle. The traction battery pack includes a plurality of battery cells and various other battery internal components that are housed inside an outer enclosure assembly for supporting the electric propulsion of the electrified vehicle. The battery internal components may generate heat during certain operating conditions.

### SUMMARY

A traction battery pack according to an exemplary aspect of the present disclosure includes, among other things, an outer enclosure assembly including a multi-layered enclosure cover and an enclosure tray. The multi-layered enclosure cover includes an inner layer, an outer layer, and a mid-layer disposed between the inner layer and the outer layer.

In a further non-limiting embodiment of the foregoing traction battery pack, the mid-layer is disposed within a pocket between the inner layer and the outer layer.

In a further non-limiting embodiment of either of the foregoing traction battery packs, the pocket is located axially between mounting flange sections of the multi-layered enclosure cover.

In a further non-limiting embodiment of any of the foregoing traction battery packs, the inner layer is a steel layer, the outer layer is an aluminum layer, and the mid-layer is a thermal resistive foam layer.

In a further non-limiting embodiment of any of the foregoing traction battery packs, the thermal resistive foam layer includes an aerogel or a polyurethane foam.

In a further non-limiting embodiment of any of the foregoing traction battery packs, the inner layer is an aluminum layer, the outer layer is an aluminum layer, and the mid-layer is a thermal resistive foam layer.

In a further non-limiting embodiment of any of the foregoing traction battery packs, the thermal resistive foam layer includes an aerogel or a polyurethane foam.

In a further non-limiting embodiment of any of the foregoing traction battery packs, the inner layer is a steel layer, the outer layer is a steel layer, and the mid-layer is an aluminum layer.

In a further non-limiting embodiment of any of the foregoing traction battery packs, the multi-layered enclosure cover is a roll-bonded structure that includes a roll bond joint that joins the inner layer to the outer layer at a mounting flange of the multi-layered enclosure cover.

In a further non-limiting embodiment of any of the foregoing traction battery packs, a mounting hole is formed through the mounting flange.

In a further non-limiting embodiment of any of the foregoing traction battery packs, a mechanical fastener is received through the mounting hole.

In a further non-limiting embodiment of any of the foregoing traction battery packs, a plurality of battery arrays are housed inside the outer enclosure assembly.

A traction battery pack according to another exemplary aspect of the present disclosure includes, among other things, an outer enclosure assembly including an enclosure tray and a multi-layered enclosure cover, and a battery array housed inside the outer enclosure assembly. The multi-layered enclosure cover is a roll-bonded structure that includes an inner layer, an outer layer, and a mid-layer.

In a further non-limiting embodiment of the foregoing traction battery pack, the inner layer is configured as a heat absorption layer for absorbing heat generated by the battery array, the outer layer is configured as a support structure for supporting internal pressures of the traction battery pack, and the mid-layer is configured as a heat sink for the inner layer.

In a further non-limiting embodiment of the foregoing battery pack, the inner layer is a steel layer, the outer layer is an aluminum layer, and the mid-layer is a thermal resistive foam layer.

In a further non-limiting embodiment of either of the foregoing battery packs, the thermal resistive foam layer includes an aerogel or a polyurethane foam.

In a further non-limiting embodiment of any of the foregoing battery packs, the inner layer is an aluminum layer, the outer layer is an aluminum layer, and the mid-layer is a thermal resistive foam layer.

In a further non-limiting embodiment of any of the foregoing battery packs, the thermal resistive foam layer includes an aerogel or a polyurethane foam.

In a further non-limiting embodiment of any of the foregoing battery packs, the inner layer is a steel layer, the outer layer is a steel layer, and the mid-layer is an aluminum layer.

In a further non-limiting embodiment of any of the foregoing battery packs, a mechanical fastener is received through a mounting hole of the multi-layered enclosure cover and the enclosure tray for securing the multi-layered enclosure cover to the enclosure tray.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a multi-layered enclosure cover of an outer enclosure assembly of a traction battery pack.

FIG. 3 is a cross-sectional view through section 3-3 of the multi-layered enclosure cover of FIG. 2.

FIG. 4 is a blown-up view of a portion B of FIG. 3.

FIG. 5 illustrates another exemplary multi-layered enclosure cover.

FIG. 6 illustrates yet another exemplary multi-layered enclosure cover.

### DETAILED DESCRIPTION

This disclosure details exemplary traction battery pack designs for use in electrified vehicles. Exemplary traction battery packs may include an outer enclosure assembly establishing an interior, and a battery array housed within the interior. The outer enclosure assembly includes a multi-layered enclosure cover designed to withstand the high temperature environment of the traction battery pack while also providing weight savings. In some embodiments, the multi-layered enclosure cover is a roll-bonded structure that includes an inner layer, an outer layer, and a mid-layer. The various layers of the roll-bonded structure may be constructed out of various materials. These and other features are discussed in greater detail in the following paragraphs of this detailed description.

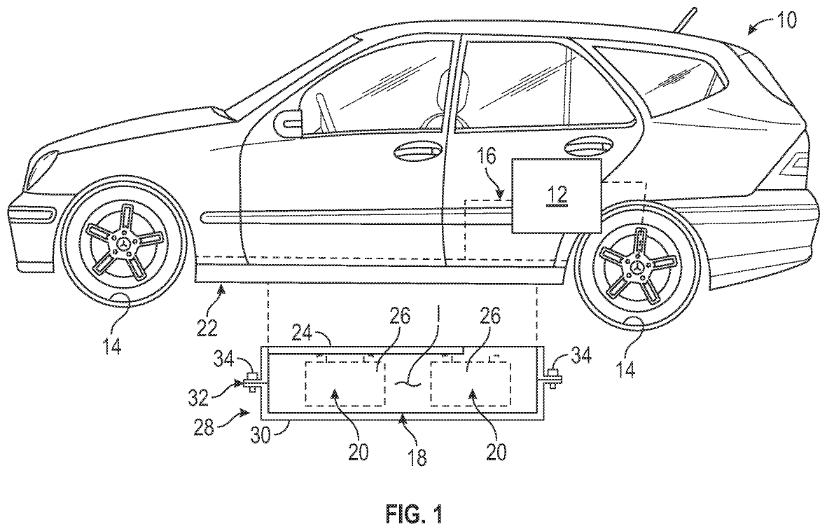

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10

A voltage bus 16 may electrically couple the electric machine 12 to a traction battery pack 18. The traction battery pack 18 is an exemplary electrified vehicle battery. The traction battery pack 18 may be a high voltage traction battery pack that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An outer enclosure assembly 28 may house each battery array 20 of the traction battery pack 18. The outer enclosure assembly 28 may be a sealed enclosure and may embody any size, shape, and configuration within the scope of this disclosure. In an embodiment, the outer enclosure assembly 28 includes a multi-layered enclosure cover 24 and an enclosure tray 30. Together, the multi-layered enclosure cover 24 and the enclosure tray 30 may establish an interior I for housing the battery arrays 20 and other battery internal components (e.g., bussed electrical center, battery electric control module, wiring, connectors, etc.) of the traction battery pack 18.

During assembly of the traction battery pack 18, the multi-layered enclosure cover 24 may be secured to the enclosure tray 30 at an interface 32 therebetween. The interface 32 may substantially circumscribe the interior I. In some implementations, mechanical fasteners 34 may be used to secure the multi-layered enclosure cover 24 to the enclosure tray 30, although other fastening methodologies (adhesion, etc.) could also be suitable.

Heat may be generated and released by the battery cells 26 during charging operations, discharging operations, extreme ambient conditions, and/or various other conditions. The traction battery pack 18 may therefore operate within a relatively high temperature environment. The outer enclosure assembly 28 typically must be designed to withstand the temperatures associated with such a high temperature environment. This disclosure is therefore directed to outer enclosure cover designs that are capable of withstanding elevated temperatures while providing better battery thermal management solutions and weight savings compared to prior enclosure covers.

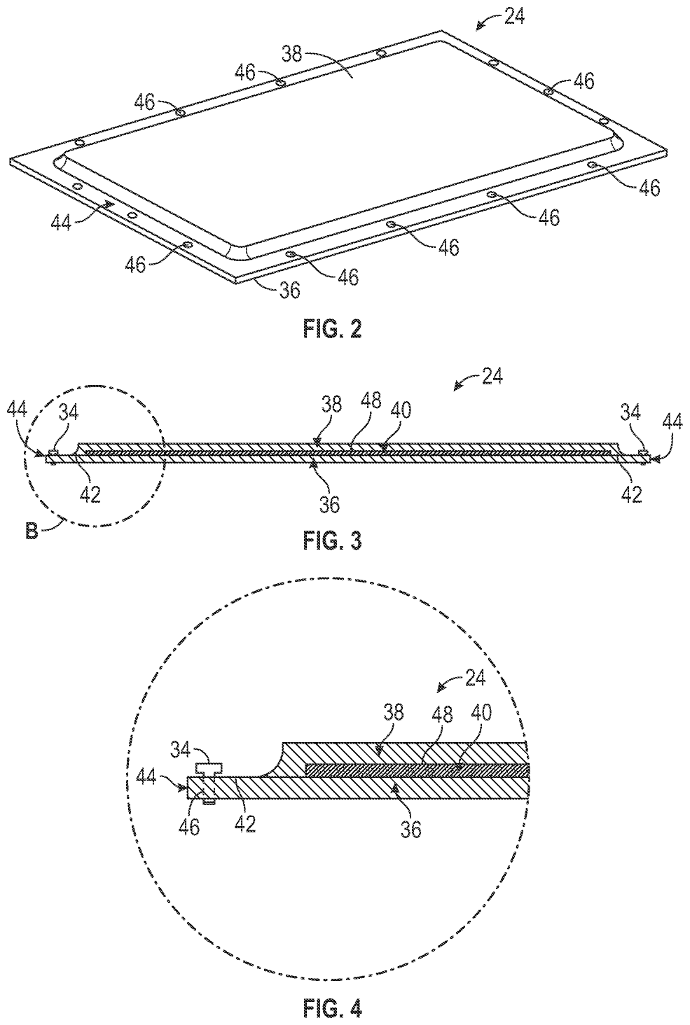

Referring now to FIGS. 2, 3, and 4, with continued reference to FIG. 1, the multi-layered enclosure cover 24 of the outer enclosure assembly 28 may include an inner layer 36, an outer layer 38, and at least one mid-layer 40 disposed between the inner layer 36 and the outer layer 38. In an embodiment, the mid-layer 40 is completely enclosed inside the multi-layered enclosure cover 24. Although three layers are shown in the exemplary embodiment, the multi-layered enclosure cover 24 could include a greater number of layers within the scope of this disclosure.

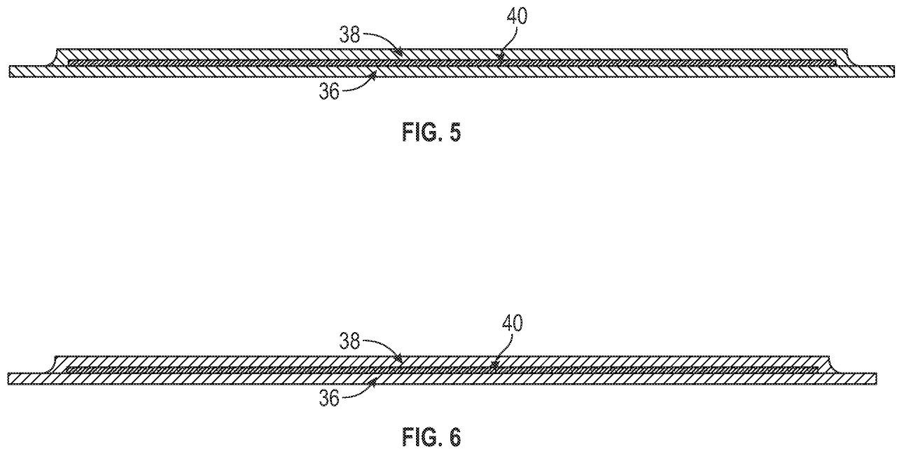

In an embodiment, the inner layer 36 is a steel layer, the outer layer 38 is an aluminum layer, and the mid-layer 40 is a thermal resistive foam layer (see FIGS. 3-4). In another embodiment, the inner layer 36 is an aluminum layer, the outer layer 38 is an aluminum layer, and the mid-layer 40 is a thermal resistive foam layer (see FIG. 5). In yet another embodiment, the inner layer 36 is a steel layer, the outer layer 38 is a steel layer, and the mid-layer 40 is an aluminum layer (see FIG. 6).

The thermal resistive foam that may be used to form the mid-layer 40 may, in some implementations, include an aerogel or a polyurethane foam having a cyclopentane blowing agent. However, other foam materials could alternatively or additionally be used.

When the multi-layered enclosure cover 24 is secured to the enclosure tray 30, the inner layer 36 is generally the layer positioned closest to the battery internal components of the traction battery pack 18, and the outer layer 38 is generally the layer located furthest from the battery internal components. The inner layer 36 may be designed to function as a heat absorption surface for absorbing heat generated inside the traction battery pack 18, the mid-layer 40 may be designed to function as a heat sink for the inner layer 36 and may include a high thermal resistance for slowing the transfer of heat to the outer layer 38, and the outer layer 38 may be designed to function as a support structure that is of sufficient strength to handle internal pressures of the traction battery pack 18.

The multi-layered enclosure cover 24 may be a roll-bonded structure. However, other bonding techniques, including but not limited to crimping, could alternatively be utilized to construct the multi-layered enclosure cover 24.

The inner layer 36 and the outer layer 38 may be joined together at a bonded joint 42 (schematically depicted in FIGS. 3 and 4). The inner layer 36 and the outer layer 38 may therefore contact one another in order to establish a mounting flange 44 of the multi-layered enclosure cover 24. One or more mounting holes 46 may be formed through the mounting flange 44. Each mounting hole 46 may accommodate one of the fasteners 34 (see FIG. 4) for securing the multi-layered enclosure cover 24 to the enclosure tray 30. The mid-layer 40 may include a shorter length compared to the inner layer 36 and the outer layer 38 and is thus does not establish part of the mounting flange 44 in the exemplary embodiment.

The inner layer 36, the outer layer 38, and the mid-layer 40 may each include a thickness that is either equal to or different compared the thickness of each of the other layers of the multi-layered enclosure cover 24. The specific thickness of each layer is thus design dependent and is not intended to limit this disclosure.

The multi-layered enclosure cover 24 may be formed as part of a roll bonding process. For example, a first sheet of material for forming the inner layer 36 and a second sheet of material for forming the outer layer 38 may be first passed through an oven in order to raise the temperature of each sheet to its eutectic point, and then the sheets of material may be passed through a pair of rollers. The rollers may rotate and apply pressure sufficient enough to melt together the first and second sheets of material across the surface area over which the sheets are in direct contact (e.g., at the bonded joint 42), thereby resulting in a single contiguous part as a final product of the roll bonding process. The bonded sheets of material may then be trimmed to a desired size of the multi-layered enclosure cover 24.

A screen printed pattern utilizing a graphite-based ink, titanium-based ink, or some other substance (or a third sheet of material for forming the mid-layer 40) may be applied to the first sheet of material prior to feeding the sheets through the oven and rollers. The screen printed pattern (or the third sheet of material), where present, inhibits the first and second sheets from bonding, allowing for the creation of unique geometries, making this flexible manufacturing process readily adaptable to various applications.

After creating the bonded joint 42 via the roll bonding process described above, a high pressure gas or liquid may then be injected near the unbonded surfaces between the inner layer 36 and the outer layer 38 in order to inflate unbonded portions of inner layer 36 and/or the outer layer 38. The inflated portions may form a pocket 48 inside the multi-layered enclosure cover 24. The pocket 48 may be located axially between mounting flange sections of the multi-layered enclosure cover 24.

A thermally resistive foam may be injected inside the multi-layered enclosure cover 24 to backfill the pocket 48. The thermal resistive foam may subsequently harden to form the mid-layer 40 inside the multi-layered enclosure cover 24.

The exemplary traction battery packs of this disclosure incorporate roll bonded multi-layered enclosure cover structures. The multi-layered enclosure cover structures are designed to withstand elevated traction battery operating temperatures while further providing battery thermal management solutions and weight savings compared to prior enclosure cover designs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an outer enclosure assembly including a multi-layered enclosure cover and an enclosure tray;
wherein the multi-layered enclosure cover includes an inner layer, an outer layer, and a mid-layer disposed between the inner layer and the outer layer.

2. The traction battery pack as recited in claim 1, wherein the mid-layer is disposed within a pocket between the inner layer and the outer layer.

3. The traction battery pack as recited in claim 2, wherein the pocket is located axially between mounting flange sections of the multi-layered enclosure cover.

4. The traction battery pack as recited in claim 1, wherein the inner layer is a steel layer, the outer layer is an aluminum layer, and the mid-layer is a thermal resistive foam layer.

5. The traction battery pack as recited in claim 4, wherein the thermal resistive foam layer includes an aerogel or a polyurethane foam.

6. The traction battery pack as recited in claim 1, wherein the inner layer is an aluminum layer, the outer layer is an aluminum layer, and the mid-layer is a thermal resistive foam layer.

7. The traction battery pack as recited in claim 6, wherein the thermal resistive foam layer includes an aerogel or a polyurethane foam.

8. The traction battery pack as recited in claim 1, wherein the inner layer is a steel layer, the outer layer is a steel layer, and the mid-layer is an aluminum layer.

9. The traction battery pack as recited in claim 1, wherein the multi-layered enclosure cover is a roll-bonded structure that includes a roll bond joint that joins the inner layer to the outer layer at a mounting flange of the multi-layered enclosure cover.

10. The traction battery pack as recited in claim 9, comprising a mounting hole formed through the mounting flange.

11. The traction battery pack as recited in claim 10, comprising a mechanical fastener received through the mounting hole.

12. The traction battery pack as recited in claim 1, comprising a plurality of battery arrays housed inside the outer enclosure assembly.

13. A traction battery pack, comprising:
an outer enclosure assembly including an enclosure tray and a multi-layered enclosure cover; and
a battery array housed inside the outer enclosure assembly,
wherein the multi-layered enclosure cover is a roll-bonded structure that includes an inner layer, an outer layer, and a mid-layer.

14. The traction battery pack as recited in claim 13, wherein the inner layer is configured as a heat absorption layer for absorbing heat generated by the battery array, the outer layer is configured as a support structure for supporting internal pressures of the traction battery pack, and the mid-layer is configured as a heat sink for the inner layer.

15. The battery pack as recited in claim 13, wherein the inner layer is a steel layer, the outer layer is an aluminum layer, and the mid-layer is a thermal resistive foam layer.

16. The battery pack as recited in claim 15, wherein the thermal resistive foam layer includes an aerogel or a polyurethane foam.

17. The battery pack as recited in claim 13, wherein the inner layer is an aluminum layer, the outer layer is an aluminum layer, and the mid-layer is a thermal resistive foam layer.

18. The battery pack as recited in claim 17, wherein the thermal resistive foam layer includes an aerogel or a polyurethane foam.

19. The battery pack as recited in claim 13, wherein the inner layer is a steel layer, the outer layer is a steel layer, and the mid-layer is an aluminum layer.

20. The battery pack as recited in claim 13, comprising a mechanical fastener received through a mounting hole of the multi-layered enclosure cover and the enclosure tray for securing the multi-layered enclosure cover to the enclosure tray.
